(19) United States
(12) Patent Application Publication
(10) Pub. No.: US 2022/0002885 A1
(43) Pub. Date: Jan. 6, 2022

(54) Solid-State Electro-Chemical Compressor

(71) Applicant: HYET HOLDING B.V., Arnhem (NL)

(72) Inventor: Albert Bos, Arnhem (NL)

(21) Appl. No.: 17/296,039

(22) PCT Filed: Nov. 21, 2019
(86) PCT No.: PCT/NL2019/050774

§ 371 Date: May 21, 2021

(30) Foreign Application Priority Data
Nov. 23, 2018 (NL) 2022066

(51) Int. Cl. C25B 9/05; C25B 9/77; C25B 15/08; C25B 9/65; C25B 15/02; C25B 1/02; C25B 1/50

(52) U.S. Cl. CPC C25B 9/05; C25B 9/77; C25B 15/08; C25B 1/50; C25B 15/02; C25B 1/02; C25B 9/65

(57) ABSTRACT

The present invention relates to a solid-state electro-chemical compressor, including a number of electro-chemical cell packages, of which each cell includes a low-pressure fluid inlet, a high-pressure fluid outlet, a membrane, arranged between the low-pressure fluid inlet and the high-pressure fluid outlet, a pair of an anode, arranged at the low-pressure fluid inlet and a cathode, arranged at the high-pressure fluid outlet side, wherein all pairs of anodes and cathodes of a cell package are connected in series to a common electric power supply; and wherein all low-pressure fluid inlets of a cell package are coupled to a common low-pressure fluid inlet and all high-pressure fluid outlets of a cell package are coupled to a common high-pressure fluid outlet wherein the common high-pressure fluid outlets of the respective cell packages are coupled to a main fluid outlet.

### CROSS-REFERENCE TO RELATED APPLICATIONS

This application is the United States national phase of International Application No. PCT/NL2019/050774 filed Nov. 21, 2019, and claims priority to The Netherlands Patent Application No. 2022066 filed Nov. 23, 2018, the disclosures of which are hereby incorporated by reference in their entirety.

### BACKGROUND OF THE INVENTION

### Field of the Invention

The present invention relates to a solid-state compressor for electrochemically compressing a fluid. The invention relates in particular to a solid-state compressor comprising one or multiple electro-chemical cell packages.

### Description of Related Art

Where conventional mechanical compressors utilize mechanical means such as pistons or rotors for the compression of a fluid, solid-state compressors rely on the electrochemical transport of said fluid through a membrane using an ionic transport mechanism. In order to compress the working fluid in an electrochemical manner, a solid-state compressor typically comprises a compressor cell that is made up of one or more stacked membrane-electrode-assemblies (also known as MEA's). The electrodes of the MEA are connected to a power supply for maintaining an electric potential difference across the electrodes. This potential difference is necessary to electrochemically move the ionized working fluid through the proton exchange membrane (commonly known as a PEM) against the pressure gradient that exists across the membrane. The direction of the electrical current hereby determines the direction of the ionic transport, wherein the low-pressure working fluid is ionized at the positively charged anode and recombined with the separated electrons at the high-pressure cathode side of the MEA.

A commonly known solid-state compressor is the electrochemical hydrogen compressor wherein hydrogen is fed to the compressor cell and oxidized to protons and electrons. The protons are then driven through the membrane and the electrons are transferred via an external circuit, after which the protons and electrons are reduced back to molecular hydrogen. In this process, the hydrogen moves against a pressure gradient from an area of low-pressure to an area of high-pressure, resulting in the pressure rise across the membrane. The compression of other working fluids, such as water of ammonia is also possible.

Solid-state compressors have several significant advantages over mechanical compressors. Namely, solid-state compressors have no moving parts, are silent and generally have a compact design. Moreover, solid-state compressors allow fluids to be compressed to very large pressures up to and above 1000 bar at operating efficiencies exceeding those of mechanical compressors. As an additional advantage, electrochemical compression also leads to the purification of the working fluid as the membrane allows for the transport of the ionized working fluid only.

State of the art electrochemical compressors comprise a package of cells or a bundle of tubes with a power supply powering all cells or tubes in series. As a consequence, the same current flows through all cells. However, due to localized differences, the cells or tubes may diverge in operating mode or efficiency may require individual adjustment. Requirements, such as a maximum current, set by a single cell, dictate the current through all cells. Similar disadvantages occur in the fluid part of the system. A leak in any of the tubes invalidates the whole system, and in particular compression capacity may drop due to pressure loss in one or a few of the cells.

It is a goal of the present invention to take away the above disadvantages.

### SUMMARY OF THE INVENTION

The invention thereto proposes a solid-state electro-chemical compressor, comprising several electro-chemical cell packages, of which each cell comprises a low-pressure fluid inlet, a high-pressure fluid outlet, a membrane, arranged between the low-pressure fluid inlet and the high-pressure fluid outlet, a pair of an anode, arranged at the low-pressure fluid inlet and a cathode, arranged at the high-pressure fluid outlet side, wherein all pairs of anodes and cathodes of a cell package are connected in series to a common electric power supply, and wherein all low-pressure fluid inlets of a cell package are coupled to a common low-pressure fluid inlet, and all high-pressure fluid outlets of a cell package are coupled to a common high-pressure fluid outlet, wherein the common high-pressure fluid outlets of the respective cell packages are coupled to a main fluid outlet.

A parallel connection of multiple series connected cells has various advantages over a series-connection only. Most important is that the compressor becomes less sensitive to failures or defects of single cells, and remedies can be applied when a single cell performs sub-optimal, resulting in less compression capacity, without having to replace the entire compressor or having to switch it off. Additionally, each cell can be operated under optimal conditions, which do not have to be the same for all cells.

Preferably, each of the low-pressure inlets of the cell packages is coupled to a main fluid inlet. From there the fluid, in particular hydrogen, is provided to each separate cell. Since all low-pressure inlets can be operated at the same pressure, no further specific precautions have to be taken. Alternatively, cells or cell packages may receive fluid from various fluid sources. This may be beneficial when no common source with sufficient output available.

In a further embodiment each of the high-pressure outlets of the cell packages is coupled to a main fluid outlet. The individual cells produce only small amounts of high-pressure fluid, and which can be collected by the cell package outlet and subsequently the main fluid outlet.

However, cells may have different electrochemical properties, be it due to wear, aging, or manufacturing circumstances, and fluid may be output with a different pressure by different cells. To avoid back-flow of high-pressure fluid each of the high-pressure fluid outlets is coupled to the main fluid outlet via a check valve that allows fluid flow in the direction from the common high-pressure outlet to the main fluid outlet only.

In a further embodiment, the common electric power supplies of various cell packages are all separate power supplies. This allows for creating optimum power conditions for each cell package and independently optimizing reconditioning conditions. This way, the cell package, or a subset of the package, remains the highest possible throughput.

In a preferred embodiment, the power supplies are provided with a monitor, for monitoring electric properties of the cells. Such a monitor may comprise electronic circuitry and/or a microprocessor, for measuring a voltage across the cell, or a current through the cell. The latter is the same for all cells in case of series connected cells. The cell voltage is indicative of the performance of that cell. When an individual cell voltage differs from the voltage across other cells, it means that its resistance differs from the other cells. Besides a different resistance, capacitive properties may indicate wear and tear of a cell. In a further embodiment, at least one cell comprises a temperature and/or pressure sensor, and the monitor is configured for registering a temperature and a pressure of said at least one cell. Based on the measurements and/or the outcome of the spectroscopy, the power supply is configured for setting a cell power optimal for powering the cell package Additionally, the power supply may be configured for reconditioning the power stack, in particular for removing water by reversing a current direction or allowing water redistribution at low or zero currents.

Various embodiments and configurations are possible, but preferably a cell package comprises approximately 8 cells, which requires a power supply that can provide voltages of 0.6 to 5 volt at high currents. A higher voltage is not preferred, since at high currents too much of the energy is dissipated as heat in the cells

The series connected electro-chemical cells are preferably arranged in a common housing. In a further embodiment, the plurality of cell packages are arranged in the same housing, and thus act as one common apparatus. The disadvantage of this setup is that the plurality of cell packages preferably need to be electrically isolated from each other. The advantage is that only one set of heavy end flanges needs to be used for retaining the pressure and sealing the cells, thus reducing the weight significantly and reducing cost.

### BRIEF DESCRIPTION OF THE DRAWING

The invention will now be elucidated into more detail with reference to the following FIGURE, in which a schematic overview of a state electro-chemical compressor of the invention is given.

### DESCRIPTION OF THE INVENTION

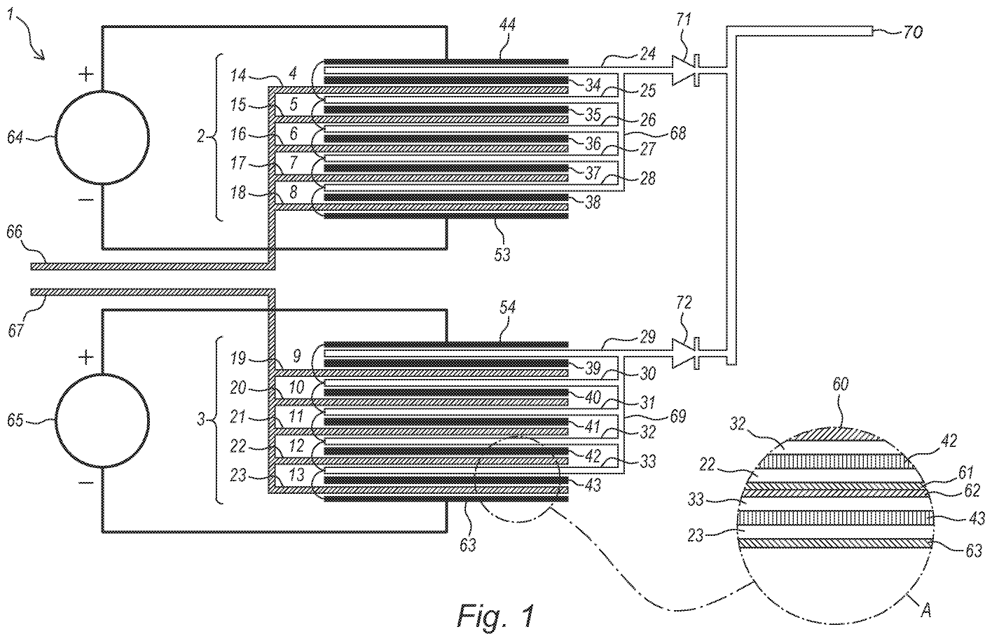

FIG. 1 shows a solid-state electro-chemical compressor 1 according to the present invention, comprising a number of multiple electro-chemical cell packages 2, 3, of which each cell 4, 5, 6, 7, 8, 9, 10, 11, 12, 13 comprises a respective low-pressure fluid inlet 14, 15, 16, 17, 18, 19, 20, 22, 23 and a high-pressure fluid outlet 24, 25, 26, 27, 28, 29, 30, 31, 32, 33, a membrane 34, 35, 36, 37, 38, 39, 40, 41, 42, 43, arranged between the low-pressure fluid inlet and the high-pressure fluid outlet, and a pair of a cathode 53, 61, 63 (not all are visible), arranged at the low-pressure fluid inlet and an anode, 44, 54, 60, 62 (not all are visible), arranged at the high-pressure fluid outlet side wherein all pairs of anodes 44-62 and cathodes 45-63 of a cell package 2, 3 are electrically connected in series to a common electric power supply 64, 65 and wherein all low-pressure fluid inlets 14, 15, 16, 17, 18, 19, 20, 22, 23 of a cell package are coupled to a common low-pressure fluid inlet 66, 67 and all high-pressure fluid outlets 24, 25, 26, 27, 28, 29, 30, 31, 32, 33 of a stack package are coupled to a common high-pressure fluid outlet 68, 69 wherein the common high-pressure fluid outlets of the respective cell packages are coupled to a main fluid outlet 70.

As visible in Detail A, a structure of anode 60, a high-pressure outlet 32, a membrane 42, a low-pressure fluid inlet 22 and a cathode 61 forms a cell 12. Anodes and cathodes of adjacent cells (61, 62) may be electrically coupled, or even be formed by one integrated piece. For enabling detailed electro technical information about individual cells, the anodes and cathodes of cells in a cell package or coupled anodes and cathodes of cells in a package may be provided with external electric contacts, for measuring purposes. These contacts may be connected to the respective power supplies, in particular to a monitor thereof. In the depicted embodiment, the common high-pressure fluid outlets 68, 69 of the cell packages are coupled to a main fluid outlet via a check valve 71, 72 that allows fluid flow in the direction from the common high-pressure outlet 68, 69 to the main fluid outlet 70 only. The common low-pressure fluid inlets 66, 67 may also be coupled to a main fluid inlet (not depicted).

The common electric power supplies 64, 65 of various cell packages are separate power supplies. In the examples shown, packages are made of 5 cells, but preferably a cell package comprises at least 8 cells, so that the electric power supply can be configured for operation of at least 0.6 volt. The scope of the invention is not limited to the described embodiment, which is an example only, but defined by the following claims.

1. A solid-state electro-chemical compressor, comprising:
Several electro-chemical cell packages, of which each cell comprises:
A low-pressure fluid inlet;
A high-pressure fluid outlet;
A membrane, arranged between the low-pressure fluid inlet and the high-pressure fluid outlet;
A pair of:
An anode, arranged at the low-pressure fluid inlet;
A cathode, arranged at the high-pressure fluid outlet side;
wherein
all pairs of anodes and cathodes of a cell package are connected in series to a common electric power supply; and
wherein
all low-pressure fluid inlets of a cell package are coupled to a common low-pressure fluid inlet;
all high-pressure fluid outlets of a cell package are coupled to a common high-pressure fluid outlet;
wherein
the common high-pressure fluid outlets of the respective cell packages are coupled to a main fluid outlet.

2. The compressor according to claim 1, wherein the common high-pressure fluid outlets of the cell packages are coupled to a main fluid outlet via a check valve that allows fluid flow in the direction from the common high-pressure outlet to the main fluid outlet only.

3. The compressor according to claim 1, wherein the common low-pressure fluid inlets of the cell packages are coupled to a main fluid inlet.

4. The compressor according to claim 1, wherein the common electric power supplies of various cell packages are all separate power supplies.

5. The compressor according to claim 1, wherein the power supplies are provided with a monitor, for monitoring electric properties of the cells.

6. The compressor according to claim 1, wherein the respective anodes and cathodes of the cell package are available as external contacts.

7. The compressor according to claim 5, wherein at least one cell comprises a temperature and/or pressure sensor, and the monitor is configured for registering a temperature and a pressure of said at least one cell.

8. The compressor according to claim 1, wherein the power supply is configured for setting a cell package power optimal for powering the cell package.

9. The compressor according to claim 1, wherein the power supply is configured for reconditioning the cell package, particularly to remove water by reversing a current direction or allowing water redistribution at low or zero current densities.

10. The compressor according to claim 1, wherein a cell package comprises at least 8 cells.

11. The compressor according to claim 1, wherein the electric power supply is configured for operation at 0.6-5.0.

12. The compressor according to claim 1, wherein at least the series connected electro-chemical cells are arranged in a common housing.

13. The compressor according to claim 12, wherein all cells are arranged in the common housing.
